(19) United States
(12) Patent Application Publication
(10) Pub. No.: US 2015/0208181 A1
(43) Pub. Date: Jul. 23, 2015

(54) RUBBING SOUND PREVENTION HEARING AID

(71) Applicant: KABUSHIKI KAISHA LEBEN HANBAI, Yokohama-shi, Kanagawa (JP)

(72) Inventor: Atsushi Takabu, Kanagawa (JP)

(21) Appl. No.: 14/421,214

(22) PCT Filed: Aug. 8, 2013
(86) PCT No.: PCT/JP2013/071545

§ 371 Date: Feb. 12, 2015

(30) Foreign Application Priority Data
Aug. 13, 2012 (JP) 2012-004963

(51) Int. Cl. H04R 25/00; G10K 11/178

(52) U.S. Cl. CPC H04R 25/453; G10K 11/178

(57) ABSTRACT

There is provided a hearing aid suppressing noise or howling caused by rubbing between a case of the hearing aid and an external object, and outputting clear intelligible sound from an earphone. The hearing aid 10 amplifies sound collected by a sound microphone 16 and outputs the amplified sound from the earphone 19. The hearing aid 10 includes the sound microphone 16 configured to collect the sound from outside and convert the sound to an electric signal, a noise microphone 17 configured to collect the noise in a casing of the hearing aid 10 and convert the noise to an electric signal, a subtraction unit 22 configured to subtract a noise microphone electric signal being the electric signal from the noise microphone 17 from a sound microphone electric signal being the electric signal from the sound microphone 16, and the earphone 19 configured to convert an electric signal obtained after the subtraction to sound and output the converted sound.

### TECHNICAL FIELD

The present invention relates to a hearing aid configured to reduce noise generated in the hearing aid. This application claims the benefit of priority from Japanese Utility Model Registration Application No. 2012-004963, filed on Aug. 13, 2012, the entire contents of which are incorporated herein by reference in those designated states that allow incorporation by reference of literature.

### BACKGROUND ART

The use of a hearing aid is widely spread with aging population. However, the hearing aid tends to generate noise sound or howling, and therefore, it is often difficult to hear human voice or the like which a user primarily desires to hear.

Today, a large number of small hearing aids integrated with earphones which are designed to be put in or hooked over an ear are commercially available. Such a hearing aid is small and thus expensive, and also requires an expensive small battery. Since such a small hearing aid has a microphone and an earphone disposed closer to each other in distance, howling tends to occur, a large burden is placed on the ear, and it is difficult to use the small hearing aid for a long time.

In order to solve such problems, for example, a hearing aid for reducing problems caused by acoustic feedback and mechanical feedback, using adaptive feedback cancellation is disclosed in the following Patent Literature 1. The invention of the Patent Literature 1 relates to a method for control of the adaptation rate in a feedback cancelling system and a hearing aid and to a hearing aid and a system that incorporate such a method.

The following Patent Literature 2 discloses frequency processing for changing a frequency characteristic of digitalized sound without changing a time axis, and time axis processing for elongating a time axis of sound without changing the pitch thereof.

The following Patent Literature 3 discloses a subtractor and a device for shifting a phase of a signal input to the subtractor in a sound signal amplitude suppression circuit having an amplitude limiting circuit for suppressing an input signal amplitude by changing potential bias as a starting point of a signal waveform or subtracting or adding another signal.

The following Patent Literature 4 discloses an invention preventing howling generated upon taking out a hearing aid from an ear hole.

Patent Literature 5 discloses a hearing aid eliminating environmental noise by providing a noise canceller at an earphone.

Some of hearing aids have an earphone separated from a hearing aid body housing a microphone or a control unit, and a rechargeable battery mounted in the hearing aid body. The hearing aids are used for while putting the hearing aid body in a pocket or while suspending the hearing aid body from a neck. Such a hearing aid looks like a portable music player or a radio. Therefore, such a hearing aid is also still demanded because use of the hearing aid is hardly noticed by other people.

### CITATION LIST

### Patent Literature

Patent Literature 1: JP 4923102 B1
Patent Literature 2: JP 3308567 B1
Patent Literature 3: JP 4825427 B1
Patent Literature 4: JP 3643896 B1
Patent Literature 5: JP 3326958 B1

### SUMMARY OF INVENTION

### Technical Problem

However, a hearing aid aggressively solving the noise or howling caused by rubbing between a case of the hearing aid and an external object cannot be found. Some hearing aids take measures to noise by interposing a bandpass filter for taking out a signal within a human voice band, but cannot fully remove the noise actually.

The present invention has been made in view of the above-described circumstances, and it is an object of the present invention is to provide a hearing aid suppressing the noise, the howling, or the like caused by rubbing between the case of the hearing aid and the external object, and outputting clear intelligible sound from an earphone.

### Solution to Problem

In order to solve the above-described object, one aspect of the present invention is, for example, a hearing aid for amplifying sound collected by a sound microphone and outputting the amplified sound from an earphone including: the sound microphone configured to collect the sound from outside, and convert the sound from outside to an electric signal; a noise microphone configured to collect noise in a casing of the hearing aid and convert the noise to an electric signal; a subtraction unit configured to subtract a noise microphone electric signal, which is the electric signal from the noise microphone, from a sound microphone electric signal, which is the electric signal from the sound microphone; and the earphone configured to convert the electric signal obtained after the subtraction to sound, and output the converted sound.

### Advantageous Effects of Invention

According to a hearing aid of the present invention, noise, howling, or the like caused by rubbing between a case exterior material, exterior material of a microphone, or the like of a hearing aid, and an external object can be suppressed, and clear intelligible sound can be output from an earphone. Therefore, an offensive noise can be reduced, and a burden on an ear can be reduced even when the hearing aid is worn for a long time.

Some inexpensive hearing aids are configured such that an earphone is separated from a hearing aid body housing a microphone or a control unit, a chargeable battery is mounted in the hearing aid body, and the hearing aid body is carried about for example by being put in a pocket or suspended from a neck. Such a hearing aid tends to generate noise by being rubbed with clothes or the like during use. However, the hearing aid of the present invention can also effectively reduce such noise.

As described above, the uncomfortable noise is effectively removed from the hearing aid, so that the hearing aid can be worn for a long time, and the senior can have increased opportunities of communication. Therefore, social participation of the senior having difficulty in hearing, which is expected to be increased, can be promoted in an aging society.

### BRIEF DESCRIPTION OF DRAWINGS

FIG. 1 is a schematic diagram illustrating an example of an external appearance of a hearing aid 10a according to an embodiment of the present invention.

FIG. 2 is a schematic diagram illustrating an example of disposition of a sound microphone 16 and a noise microphone 17 in a casing 11.

FIG. 3 is a block diagram illustrating a noise removal principle.

FIG. 4 is a schematic diagram illustrating an example of an external appearance of a hearing aid 10b according to another embodiment.

FIG. 5 is a schematic diagram illustrating an example of an external appearance of a hearing aid 10c according to another embodiment.

FIG. 6 is a schematic diagram illustrating another example of disposition of the sound microphone 16 and the noise microphone 17 in the casing 11.

FIG. 7 is a schematic diagram illustrating another example of disposition of the sound microphone 16 and the noise microphone 17 in the casing 11.

FIG. 8 is a schematic diagram illustrating another example of disposition of the sound microphone 16 and the noise microphone 17 in the casing 11.

FIG. 9 is a schematic diagram illustrating another example of disposition of the sound microphone 16 and the noise microphone 17 in the casing 11.

FIG. 10 is a schematic diagram illustrating an example of an external appearance of a hearing aid 10d according to another embodiment.

FIG. 11 is a schematic diagram illustrating an example of an external appearance of a hearing aid 10e according to another embodiment.

### DESCRIPTION OF EMBODIMENT

An embodiment of the present invention will be described below with reference to drawings.

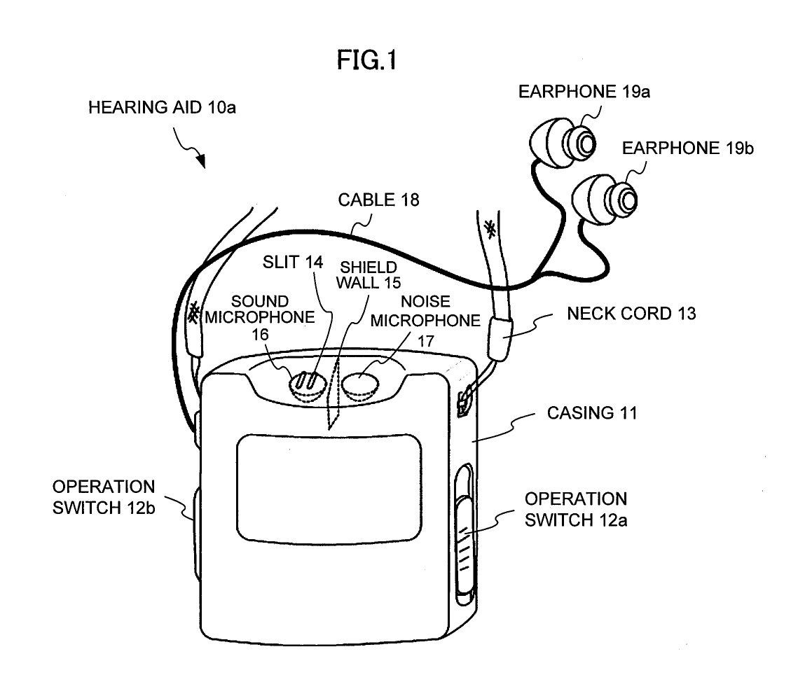

FIG. 1 is a schematic diagram illustrating an example of an external appearance of a hearing aid 10a according to an embodiment of the present invention. In the hearing aid 10a according to the present embodiment, earphones 19 and a casing 11 including a sound microphone 16 for collecting sound are connected through a cable 18, and used while suspending the casing 11 from a neck using a neck cord 13, while putting the casing 11 in a breast pocket, or while suspending the casing 11 from a neck. The earphone 19 may include a speaker like headphones, and any earphone including such an earphone will be described as the earphone in the present invention.

In the casing 11, the sound microphone 16 and a noise microphone 17 are provided. The sound microphone 16 collects sound from outside and converting the external sound to an electric signal. The noise microphone 17 collects noise generated in the casing 11. In the casing 11, a slit 14 is provided at a position at which the sound microphone 16 is provided, and the sound microphone 16 is configured to collect the sound from outside the casing 11 through the slit 14. In the casing 11, a shield wall 15 is provided between the sound microphone 16 and the noise microphone 17.

The hearing aid 10 of the present embodiment is used while suspending the casing 11 including the sound microphone 16 from a neck, or while putting the casing 11 in the breast pocket, so that noise is generated by being rubbed with clothes or the like of a user each time the user moves. When an operation switch 12 is operated, the noise is also generated due to contact between a finger and the operation switch 12 or the casing 11.

Such noise is transmitted through the casing 11, and captured by the sound microphone 16 together with sound desired to be heard primarily which enters through the slit 14. The volume of the noise itself is not large, but the noise is generated at a position near the sound microphone 16, so that such noise is often captured by the sound microphone 16, as the noise having a sound volume larger than that of the sound desired to be heard primarily which enters through the slit 14.

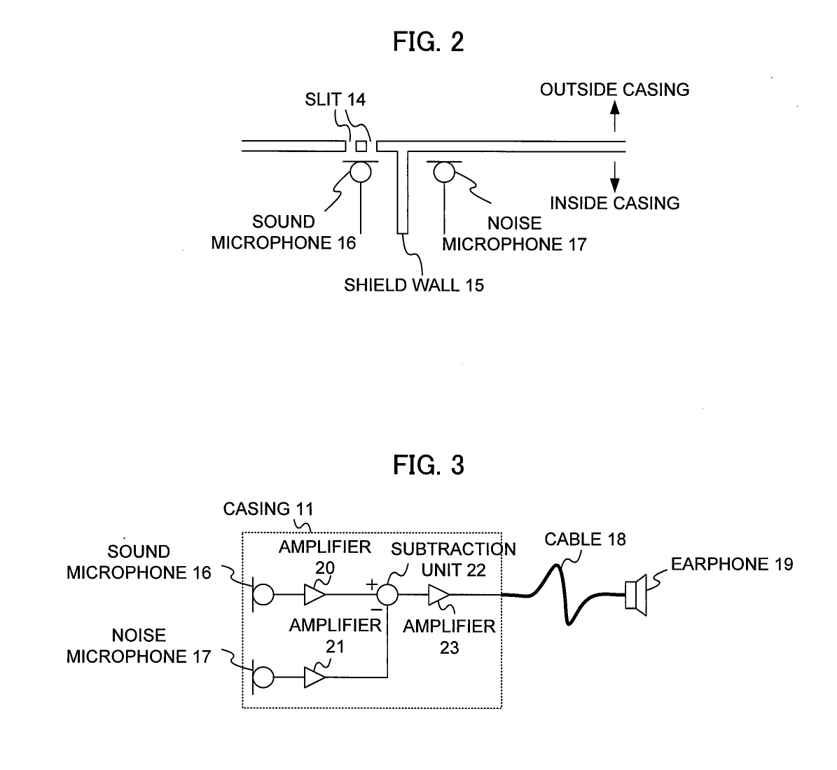

FIG. 2 is a schematic diagram illustrating disposition of the sound microphone 16 and the noise microphone 17 in the casing 11.

As illustrated in FIG. 2, the slit 14 is provided in front of the sound microphone 16. Since the sound desired to be heard by a hearing aid user is sound transmitted through air, the sound transmitted through air is collected by the sound microphone 16 through the slit 14.

Meanwhile, a slit is not provided at a portion of the casing 11 near the noise microphone 17. Therefore, the sound transmitted through air is not captured by the noise microphone 17.

The shield wall 15 is provided between the sound microphone 16 and the noise microphone 17. Therefore, even when the sound transmitted through air enters the casing 11 through the slit 14, the sound directed to the noise microphone 17 is considerably reduced in the casing 11.

In the casing 11, the sound microphone 16 and the noise microphone 17 are disposed as illustrated in FIG. 2, so that the sound transmitted through air and noise for example caused by rubbing between the casing 11 and another object are captured by the sound microphone 16, and the sound transmitted through air is unlikely to be captured, but the noise for example caused by rubbing between the casing 11 and another object is mainly captured by the noise microphone 17.

FIG. 3 is a block diagram illustrating a principle of noise removal.

The sound collected by the sound microphone 16 is converted to the electric signal, and the electric signal is amplified to a predetermined level by the amplifier 20. Here, the sound captured by the sound microphone 16 includes the sound transmitted through air and the noise for example caused by rubbing between the casing 11 and another object.

The sound captured by the noise microphone 17 is converted to an electric signal, and the electric signal is amplified to a predetermined level by the amplifier 21. Here, the sound captured by the noise microphone 17 includes little sound transmitted through air, but mainly includes the noise for example caused by rubbing between the casing 11 and another object.

The subtraction unit 22 subtracts the electric signal of the sound amplified to the predetermined level by the amplifier 21, from the electric signal of the sound amplified to the predetermined level by the amplifier 20. Therefore, the electric signal subjected to subtraction processing by the subtraction unit 22 is hardly reduced in electric signal level corresponding to a component of sound transmitted through air, but considerably reduced in electric signal level corresponding to a noise component for example caused by rubbing between the casing 11 and another object.

The amplifier 23 transmits the electric signal subjected to the subtraction processing by the subtraction unit 22 to the earphone 19 through the cable 18. The earphone 19 converts the electric signal received from the amplifier 23 to sound and output the converted sound.

Therefore, the earphone 19 can output clear sound in which the noise for example caused by rubbing between the casing 11 and another object is suppressed.

It is noted that the smaller a difference between a noise component collected by the sound microphone 16, and a noise component collected by the noise microphone 17 in amplitude, frequency distribution, or the like, the smaller the noise component remaining in the electric signal after subtraction processing by the subtraction unit 22. Therefore, it is preferable that the sound microphone 16 and the noise microphone 17 use microphones having characteristics closer to each other as much as possible.

For example, the sound microphone 16 and the noise microphone 17 are preferably used which have the same standard, the same model number, and the same lot.

The sound microphone 16 or the noise microphone 17 may not have the amplifier 20 or the amplifier 21 depending on selection.

As one of specific methods of achieving the subtraction unit 22, for example, the positive electrode side of an output terminal of the sound microphone 16 may be connected to an input terminal of the amplifier 23, the negative electrode side of the output terminal of the sound microphone 16 may be connected to the positive electrode side of an output terminal of the noise microphone 17, and the negative electrode side of the output terminal of the noise microphone 17 may be connected to a ground terminal of the amplifier 23.

Connection as described above allows that an electric signal of the noise collected by the noise microphone 17 and an electric signal of the noise collected by the sound microphone 16 are synthesized in antiphase, the electric signal of the noise collected by the sound microphone 16 is cancelled, and the electric signal corresponding to the component of sound transmitted through air, collected by the sound microphone 16 is appropriately amplified by the amplifier 23.

A bandpass filter for extracting a signal to be heard, for example, a signal within a human voice band of approximately 300 Hz to 3 KHz (or attenuating a signal outside the voice band) may be used to reproduce a clearer sound having the voice band by performing the subtraction processing after the signal within the human voice band is extracted from the electric signals collected by the sound microphone 16 and the noise microphone 17.

In this case, the amplifier 20 may be provided in front of a first bandpass filter, or between the first bandpass filter and the subtraction unit 22. Similarly, the amplifier 21 may be provided in front of a second bandpass filter, or between the second bandpass filter and the subtraction unit 22.

A third bandpass filter for attenuating a signal outside the human voice band may be provided between the sound microphone 16 and the subtraction unit 22, and a fourth bandpass filter for attenuating a signal outside the human voice band and a band rejection filter for attenuating a signal within the human voice band may be provided between the noise microphone 17 and the subtraction unit 22.

In this case, the amplifier 20 may be provided in front of the third bandpass filter, or between the third bandpass filter and the subtraction unit 22. The amplifier 21 may be provided in front of the fourth bandpass filter, between the fourth bandpass filter and the band rejection filter, or between the band rejection filter and the subtraction unit 22.

Therefore, sound within the human voice band can be made clear. The sound microphone 16 and the noise microphone 17 may be amplified before passing through the filter circuit. An amplifier circuit may include a circuit for amplifying any range, or adjusting a range or volume to be amplified.

The embodiment of the present invention has been described above. It is noted that, in this embodiment, an analog circuit has been described, but the sound may be digitally converted before subtraction, and a circuit for adjusting the volume of sound within a range after the digital conversion may be incorporated. Description of them will be omitted.

As apparent from the description, according to the hearing aid 10 of the present embodiment, the noise caused by rubbing between the casing 11 of the hearing aid 10 and the external object is suppressed, and clear intelligible sound can be output from the earphone 19.

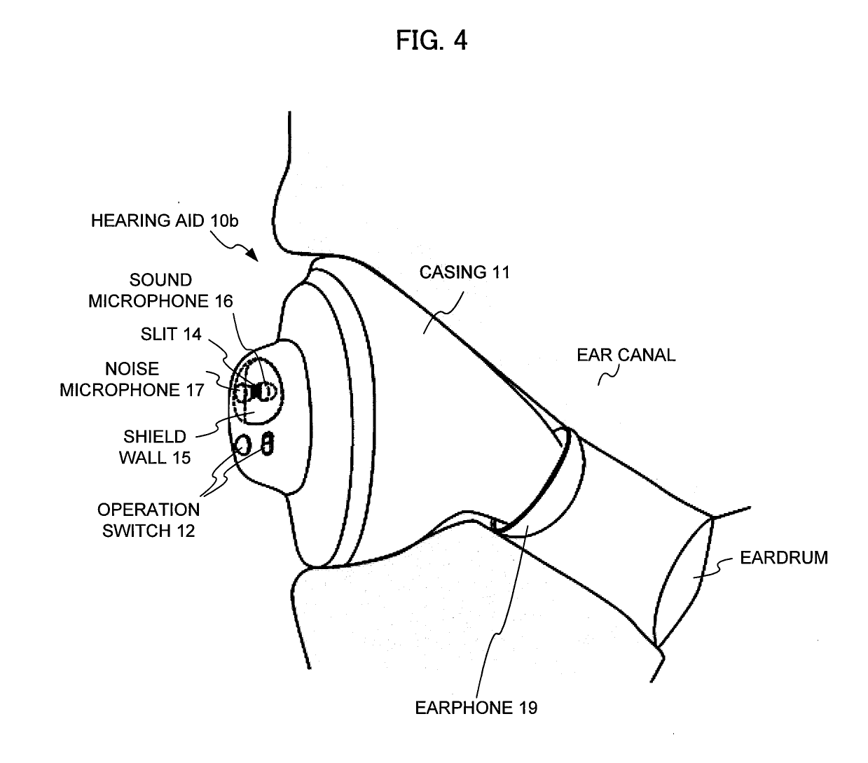

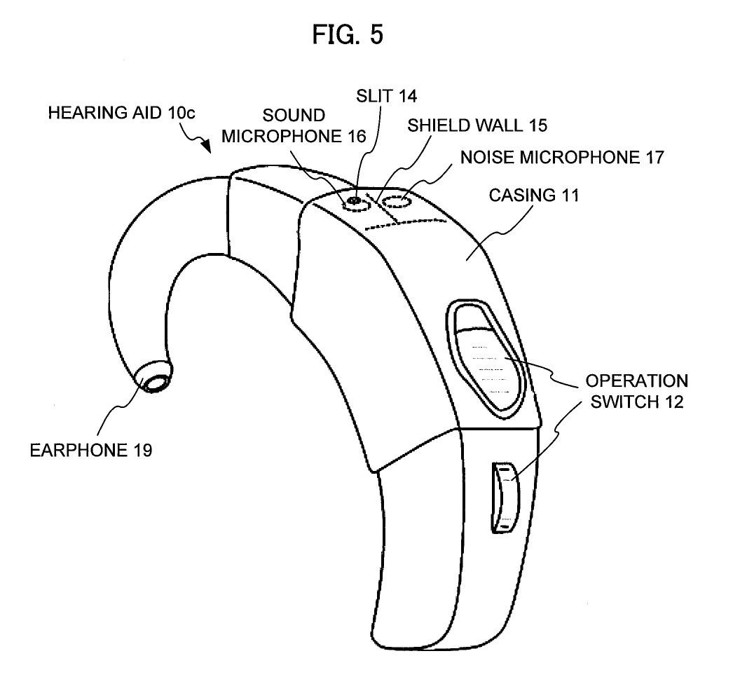

It is noted that, in the above-described embodiment, an example of the hearing aid 10a used while being suspended from a neck has been described, but the present invention is not limited to this example, and this invention can be also applied to, for example, a hearing aid 10b used while being put in an ear hole as illustrated in FIG. 4, or a hearing aid 10c used while being hooked over an ear as illustrated in FIG. 5.

In the hearing aid 10b used while being put in the ear hole, for example as illustrated in FIG. 4, the sound microphone 16 and the noise microphone 17 are provided in the casing 11, the slit 14 is provided in front of the sound microphone 16, and the shield wall 15 is provided between the sound microphone 16 and the noise microphone 17.

Also in the hearing aid 10c used while being hooked over the ear, for example as illustrated in FIG. 5, the sound microphone 16 and the noise microphone 17 are provided in the casing 11, the slit 14 is provided in front of the sound microphone 16, and the shield wall 15 is provided between the sound microphone 16 and the noise microphone 17.

In the hearing aid 10b used while being put in the ear hole or the hearing aid 10c used while being hooked over the ear, the casing 11 is less likely to make contact with clothes or the like during use, but when the hearing aid 10b is removed or the operation switch 12 is operated with a finger, the finger makes contact with the hearing aid 10b, and the noise is generated, accordingly. Additionally, for example when the hearing aid is moved with the movement of jaws during a meal, makes contact with hair, makes contact with a coat, or is hit with wind on strong windy day, the noise is also generated similarly. Even in such a situation, the present invention suppresses uncomfortable noise, and reduces a burden on the ear.

In the hearing aid 10 illustrated in FIG. 4 or 5, the sound microphone 16 and the speaker 19 are disposed closer in distance and housed in the same casing 11, and the sound output from the speaker 19 may be captured again by the sound microphone 16 through the casing 11 and cause the howling, depending on the volume of sound output from the speaker 19 or the sensitivity of the sound microphone 16.

However, in the hearing aid 10 illustrated in FIG. 4 or 5, vibration transmitted through the casing 11 is also captured by the noise microphone 17 as sound. As described in FIG. 3, an electric signal of the sound captured by the noise microphone 17 is subtracted from an electric signal of the sound captured by the sound microphone 16 by the subtraction unit 22.

Accordingly, an electric signal obtained after the subtraction by the subtraction unit 22 has little sound component output from the speaker 19 and returned through the casing 11. Therefore, the hearing aid 10 of the present embodiment can also effectively suppress the generation of the howling.

In the above-described embodiment, as illustrated in FIG. 2, the noise microphone 17 is disposed to be directed in the same direction as the sound microphone 16, but the present invention is not limited to this embodiment, and the noise microphone 17 may be disposed to be directed in a different direction from the sound microphone 16.

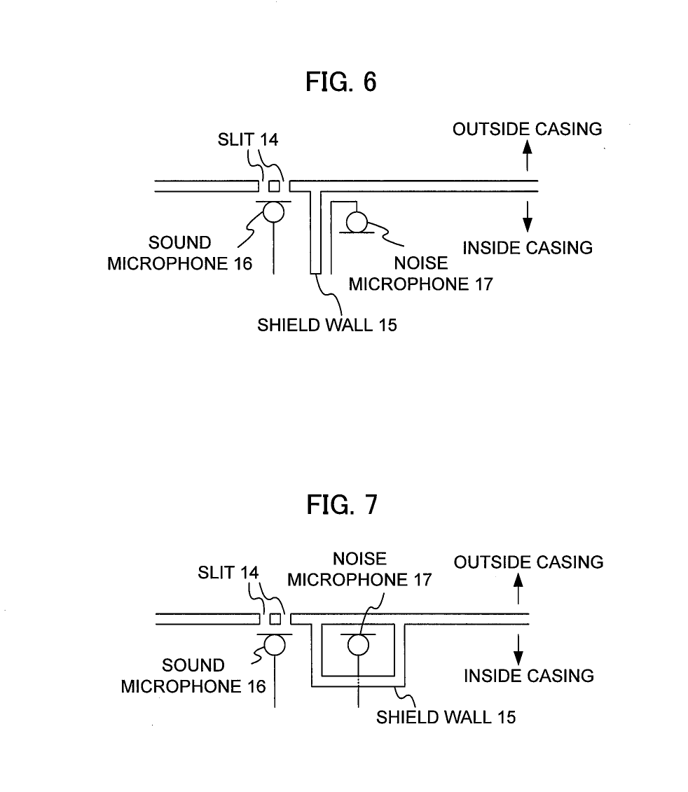

For example, as illustrated in FIG. 6, the sound microphone 16 may be mounted to be directed outside the casing 11 through the slit 14, and the noise microphone 17 may be mounted to be directed inside the casing 11. Therefore, the noise microphone 17 can efficiently capture the noise component for example caused by rubbing between the casing 11 and another object and transmitted to the inside of the casing 11 through the casing 11.

For example, as illustrated in FIG. 7, the shield wall 15 may be provided in the casing 11 to surround the noise microphone 17. With this configuration, the noise microphone 17 is prevented from capturing the sound, even when the sound transmitted through air enters the casing 11 through the slit 14. Therefore, when the electric signal of the sound captured by the noise microphone 17 is subtracted from the electric signal of the sound captured by the sound microphone 16 by the subtraction unit 22, a reduction of the electric signal of the component of sound transmitted through air can be suppressed.

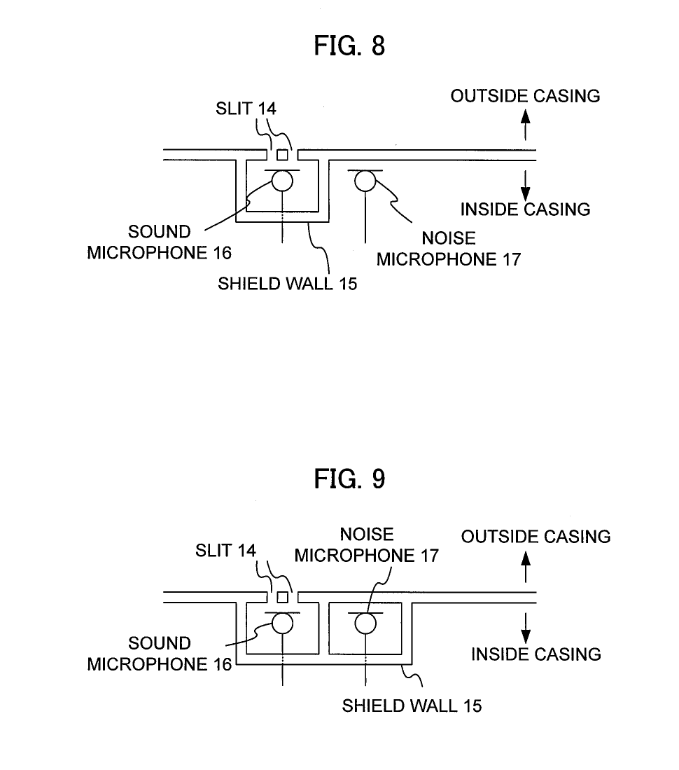

In contrast, for example as illustrated in FIG. 8, the shield wall 15 may be provided in the casing 11 to surround the sound microphone 16. With this configuration, the noise microphone 17 is also prevented from capturing the sound, even when the sound transmitted through air enters the casing 11 through the slit 14.

For example as illustrated in FIG. 9, the shield wall 15 may be provided in the casing 11 to individually surround the sound microphone 16 and the noise microphone 17. With this configuration, influence on the volume of the noise collected by the sound microphone 16 or the noise microphone 17 can be reduced, even when circuit arrangement or size of the space in the casing 11 is changed, so that freedom in design of the casing 11 or the inside of the casing 11 can be increased.

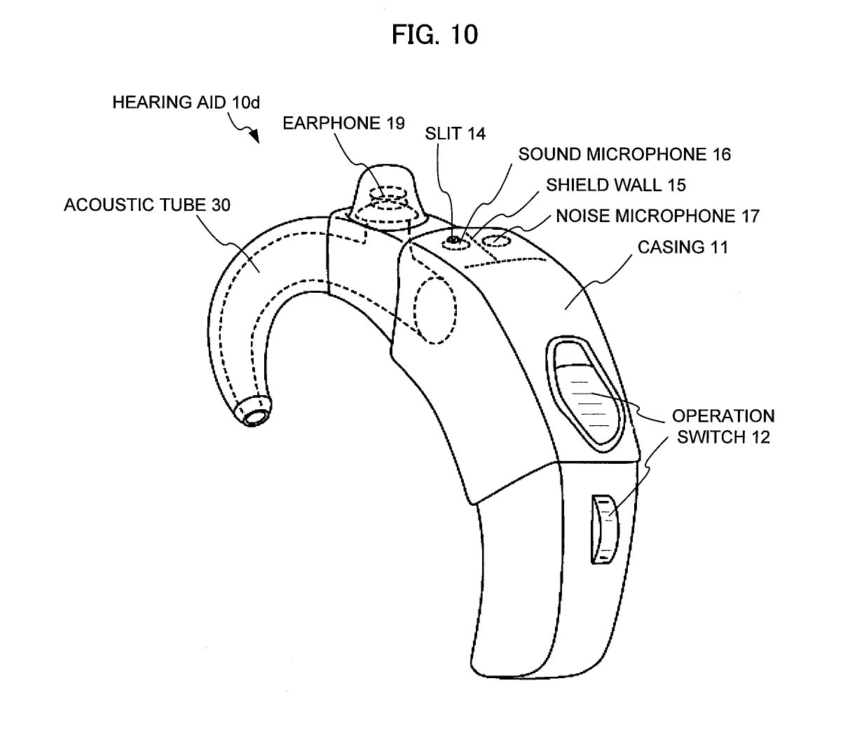

FIG. 10 illustrates an example of a hearing aid mounted with a noise canceller for adding an electric signal obtained by amplifying and phase-inverting a noise microphone electric signal of the noise microphone 17 to an amplified sound microphone electric signal. The hearing aid 10d illustrated in FIG. 10 is characterized by an earphone provided at the upper part of an acoustic tube 30 having a closed back side, to be directed toward the acoustic tube 30. The other structures are similar to those of FIG. 5.

The sound microphone 16 may have a form in which the microphone 16 is covered with an exterior material projecting from the casing 11, and the exterior material is provided with the slit 14. In this case, the noise microphone 17 also has a form without a slit.

Although not particularly described in each example, it should be understood that the sound microphone 16 is covered with a cushioning material or the like so that the microphone 16 picks up minimum sound from the casing 11 or the exterior material.

FIG. 6 may be applied to FIGS. 7, 8, and 9. For example, the noise microphone 17 illustrated in each of FIGS. 7, 8, and 9 may be mounted to be directed inside the casing 11.

The noise microphone 17 mounted to be directed inside the casing 11 may employ a directional microphone. Therefore, the noise microphone 17 tends to pick up noise (e.g., sound caused by rubbing between the casing 11 and the external object) transmitted through or in the casing 11, and is unlikely to pick up sound from outside. Therefore, a sound signal in which the noise is further suppressed is output from the amplifier 23.

The sound microphone 16 and the noise microphone 17 are preferably mounted on a surface side of the casing 11, not making contact with the external object. The sound microphone 16 is preferably mounted to be directed outside the casing 11, and the noise microphone 17 is preferably mounted to be directed inside the casing 11.

For example, in the hearing aid having a square columnar shape and used while being suspended from a neck to a chest, or the hearing aid used while being put in a breast pocket, the sound microphone 16 and the noise microphone 17 are mounted on the upper surface side of the casing. The sound microphone 16 is mounted to be directed outside the casing, and the noise microphone 17 is mounted to be directed inside the casing. More specifically, as illustrated in FIG. 1, the sound microphone 16 and the noise microphone 17 are mounted on the upper surface side of the casing 11. The sound microphone 16 is mounted to be directed outside the casing 11 (mounted toward the slit 14), and the noise microphone 17 is mounted to be directed inside the casing 11 (downward in FIG. 1). Therefore, the sound microphone 16 easily picks up the sound from outside the casing 11. The noise microphone 17 easily picks up noise caused by rubbing with clothes or the like, and transmitted through or in the casing 11, and is unlikely to pick up the sound from outside. Accordingly, the sound signal in which the noise is further suppressed is output from the amplifier 23.

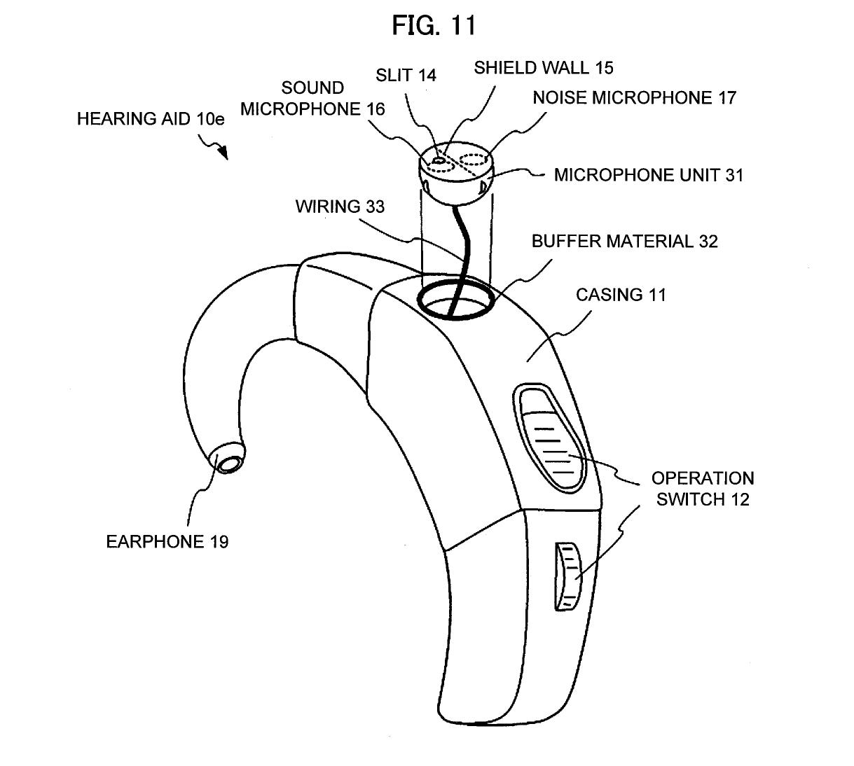

As illustrated in FIG. 11, a hearing aid 10e may have a microphone unit 31 separated from the casing 11. The microphone unit 31 has a semi-spherical shape, and has the shield wall 15 at the center thereof. The sound microphone 16 and the noise microphone 17 are provided across the shield wall 15 in the microphone unit 31. The slit 14 is provided in front of the sound microphone 16.

The microphone unit 31 is configured to be fitted to the casing 11. The microphone unit 31 is fitted to the casing 11 so that the sound microphone 16 and wiring 33 of the noise microphone 17 are housed in the casing 11, and a flat surface portion (surface side having the slit 14) of the microphone unit 31 is flush with the surface of the casing 11.

A portion of the casing 11 to which the microphone unit 31 is fitted (contact portion) is provided with an O-ring-shaped buffer material 32. The buffer material 32 includes for example sponge or rubber. That is, the buffer material 32 functions to transmit minimum noise transmitted from the casing 11 to the microphone unit 31. Therefore, for example, sound or the like caused by rubbing between the casing 11 and the external object is unlikely to enter the sound microphone 16.

Even if the sound or the like caused by rubbing between the casing 11 and the external object is picked up by the sound microphone 16, the sound is suppressed by the noise microphone 17. The noise microphone 17 may be provided to be directed inside the microphone unit 31. The buffer material 32 may include a spring or the like. For example, a plurality of springs may be provided between the microphone unit 31 and the casing 11 to float the microphone unit 31 from the casing 11.

Although the present invention has been described using the embodiment, the technical scope of the present invention is not limited to the scope described in the above embodiment. It is apparent to those skilled in the art that various alterations or modifications can be made in the above embodiment. It is apparent from descriptions of scope of claim for utility model registration that modes with the addition of such alterations or modifications can also be incorporated in the technical scope of the present invention.

### REFERENCE SIGNS LIST

10 hearing aid
11 casing
12 operation switch
13 neck cord
14 slit
15 shield wall
16 sound microphone
17 noise microphone
18 cable
19 earphone
20 amplifier
21 amplifier
22 subtraction unit
23 amplifier
31 microphone unit
32 buffer material
33 wiring

1. A hearing aid for amplifying sound collected by a sound microphone and outputting the amplified sound from an earphone, the hearing aid comprising:
a sound microphone configured to collect the sound from outside, and convert the sound from outside to an electric signal;
a noise microphone configured to collect noise in a casing of the hearing aid and convert the noise to an electric signal;
a subtraction unit configured to subtract a noise microphone electric signal, which is the electric signal from the noise microphone, from a sound microphone electric signal, which is the electric signal from the sound microphone; and
a earphone configured to convert the electric signal obtained after the subtraction to sound, and output the converted sound.

2. The hearing aid according to claim 1, further comprising:
a first amplification unit provided between the sound microphone and the subtraction unit; and
a second amplification unit provided between the noise microphone and the subtraction unit.

3. The hearing aid according to claim 1, wherein the subtraction unit performs subtraction using a subtraction circuit or phase inversion.

4-11. (canceled)
